(19) United States
(12) Patent Application Publication
(10) Pub. No.: US 2025/0292692 A1
(43) Pub. Date: Sep. 18, 2025

(54) INFORMATION PROCESSING APPARATUS, AIRCRAFT CONTROL METHOD, AND METHOD FOR IMPROVING TRAVEL MAAS

(71) Applicant: TOYOTA JIDOSHA KABUSHIKI KAISHA, Toyota-shi Aichi-ken (JP)

(72) Inventors: Akira HIROTA, Anjo-shi Aichi-ken (JP); Takashi SAKUI, Nagoya-shi Aichi-ken (JP); Keisuke SUGINO, Nagakute-shi Aichi-ken (JP); Masamichi KUWAJIMA, Nagoya-shi Aichi-ken (JP); Masashi HISATOMI, Nagakute-shi Aichi-ken (JP); Yasuhiro KOBATAKE, Nagoya-shi Aichi-ken (JP); Takahiro TANAKA, Shibuya-ku Tokyo-to (JP)

(73) Assignee: TOYOTA JIDOSHA KABUSHIKI KAISHA, Toyota-shi Aichi-ken (JP)

(21) Appl. No.: 19/074,920

(22) Filed: Mar. 10, 2025

(30) Foreign Application Priority Data
Mar. 13, 2024 (JP) 2024-039443

(51) Int. Cl. G08G 5/54; B64D 45/00; G08G 5/55; G08G 5/76

(52) U.S. Cl. CPC G08G 5/54; B64D 45/0005; G08G 5/55; G08G 5/76

(57) ABSTRACT

An information processing apparatus includes a controller, and the controller is configured to acquire body information indicating whether an aircraft has a fixed wing mode from the aircraft in a case in which an airport is congested and the aircraft is about to land at the airport, and notify the aircraft of an instruction to hold in air using the fixed wing mode in a case in which the aircraft has the fixed wing mode, and notify the aircraft of an instruction to hold in air using a vertical flight mode in a case in which the aircraft does not have the fixed wing mode.

### CROSS-REFERENCE TO RELATED APPLICATION

This application claims priority to Japanese Patent Application No. 2024-039443, filed on Mar. 13, 2024, the entire contents of which are incorporated herein by reference.

### TECHNICAL FIELD

The present disclosure relates to an information processing apparatus, an aircraft control method, and a method for improving travel MaaS.

### BACKGROUND

Technology for controlling the takeoff and landing of aircraft is known. For example, Patent Literature (PTL) 1 discloses setting a layered area consisting of at least one layer over an airport and setting, when an aircraft holds over the airport, an area occupied by the aircraft in the layered area where the aircraft flies and in at least one of the layered areas above and below.

### CITATION LIST

### Patent Literature

PTL 1: JP 2023-000617 A

### SUMMARY

However, the technology described in PTL 1 does not consider energy efficiency when the aircraft holds over the airport. Therefore, there is room for improvement in energy efficiency when aircraft hold in the air.

It would be helpful to improve energy efficiency when aircraft hold in the air.

An information processing apparatus according to an embodiment of the present disclosure includes a controller, and is an information processing apparatus configured to communicate with aircraft,
wherein the controller is configured to:
   acquire body information indicating whether an aircraft has a fixed wing mode from the aircraft in a case in which an airport is congested and the aircraft is about to land at the airport; and
   notify the aircraft of an instruction to hold in air using the fixed wing mode in a case in which the aircraft has the fixed wing mode, and notify the aircraft of an instruction to hold in air using a vertical flight mode in a case in which the aircraft does not have the fixed wing mode.

An aircraft control method according to an embodiment of the present disclosure includes:
acquiring, by an information processing apparatus configured to communicate with aircraft, body information indicating whether an aircraft has a fixed wing mode from the aircraft in a case in which an airport is congested and the aircraft is about to land at the airport; and
notifying, by the information processing apparatus, the aircraft of an instruction to hold in air using the fixed wing mode in a case in which the aircraft has the fixed wing mode, and notifying, by the information processing apparatus, the aircraft of an instruction to hold in air using a vertical flight mode in a case in which the aircraft does not have the fixed wing mode.

A method for improving travel MaaS according to an embodiment of the present disclosure includes processing steps executed by the above information processing apparatus.

According to an embodiment of the present disclosure, it is possible to improve energy efficiency when aircraft hold in the air.

### BRIEF DESCRIPTION OF THE DRAWINGS

In the accompanying drawings:

FIG. 1 is a diagram illustrating a schematic configuration of an information processing system according to an embodiment of the present disclosure;

FIG. 2 is a diagram illustrating a schematic configuration of an aircraft according to an embodiment of the present disclosure;

FIG. 3 is a flowchart illustrating first example operations of an information processing apparatus according to an embodiment of the present disclosure; and

FIG. 4 is a flowchart illustrating second example operations of the information processing apparatus according to an embodiment of the present disclosure.

### DETAILED DESCRIPTION

An embodiment will be described in detail below, with reference to the drawings.

### <Configuration of Information Processing System>

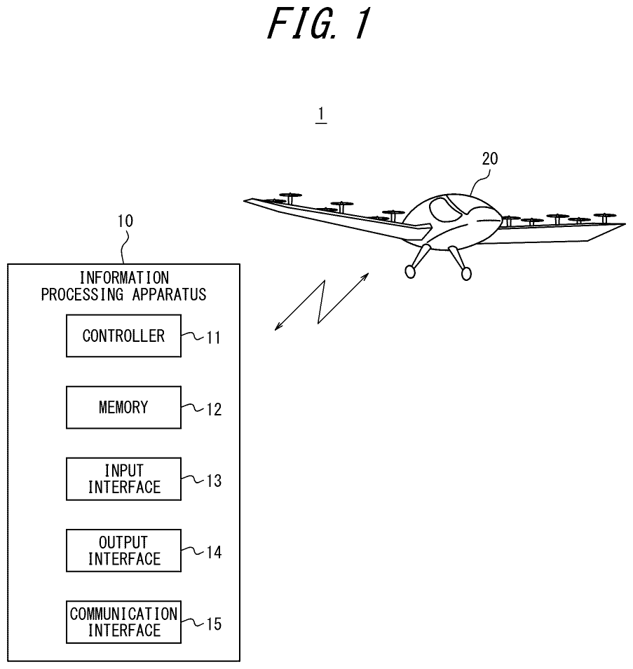

A configuration of an information processing system according to an embodiment will be described with reference to FIG. 1. An information processing system 1 illustrated in FIG. 1 includes an information processing apparatus 10 and an aircraft 20.

The information processing apparatus 10 is a server that transmits data to the aircraft 20, for example, the control apparatus for the aircraft 20. The information processing apparatus 10 may manage the airports where the aircraft 20 takes off and lands.

The aircraft 20 is, for example, an electric Vertical Take Off and Landing (eVTOL) aircraft. The eVTOL aircraft has a cabin similar in size to a passenger car that can accommodate one or more passengers, and fixed wings and/or rotary wings for generating lift and thrust. The aircraft 20 is not limited to an eVTOL aircraft, but may include an electric Short Take Off and Landing (eSTOL) aircraft, a helicopter, a drone, etc.

The aircraft 20 has at least one of the following flight modes: “fixed wing mode”, in which it flies forward with fixed wings, and “vertical flight mode”, in which it flies vertically with rotary or fixed wings. If the aircraft 20 has fixed wings but no rotor blades, the fixed wings allow it to cruise with less power, but it cannot take off and land vertically and often requires a runway for takeoff and landing. However, VTOL fixed wing aircraft capable of vertical takeoff and landing have also been developed. If the aircraft 20 has rotor blades but no fixed wings, it can take off and land vertically and stop in mid-air (hovering), but it consumes more power and is less energy efficient because it constantly rotates its propellers. If the aircraft 20 has fixed and rotary wings, it can take off and land vertically and stop in mid-air with the rotary wings and fly forward with the fixed wings, eliminating the need for a runway.

### <Information Processing Apparatus Configuration>

Next, a configuration of an information processing apparatus according to an embodiment will be described with reference to FIG. 1. The information processing apparatus 10 illustrated in FIG. 1 includes a controller 11, a memory 12, an input interface 13, an output interface 14, and a communication interface 15.

The controller 11 includes at least one processor, at least one programmable circuit, at least one dedicated circuit, or any combination thereof. The processor is a general purpose processor, such as a central processing unit (CPU) or a graphics processing unit (GPU), or a dedicated processor specialized for particular processing. The programmable circuit is, for example, a field-programmable gate array (FPGA). The dedicated circuit is, for example, an application specific integrated circuit (ASIC). The controller 11 executes processes related to operations of the information processing apparatus 10 while controlling components of the information processing apparatus 10.

The memory 12 includes at least one semiconductor memory, at least one magnetic memory, at least one optical memory, or any combination thereof. The semiconductor memory is, for example, random access memory (RAM), read only memory (ROM) or flash memory. The RAM is, for example, static random access memory (SRAM) or dynamic random access memory (DRAM). The ROM is, for example, electrically erasable programmable read only memory (EEPROM). The flash memory is, for example, a solid-state drive (SSD). The magnetic memory is, for example, a hard disk drive (HDD). The memory 12 functions as, for example, a main memory, an auxiliary memory, or a cache memory. The memory 12 stores information to be used for the operations of the information processing apparatus 10 and information obtained by the operations of the information processing apparatus 10.

The input interface 13 includes at least one interface for input. The interface for input is, for example, a physical key, a capacitive key, a pointing device, a touch screen integrally provided with the display, or a microphone. The input interface 13 accepts an operation for inputting data to be used for the operations of the information processing apparatus 10. The input interface 13 may be connected to the information processing apparatus 10 as an external input device, instead of being included in the information processing apparatus 10. As an interface for connection, any interface compliant with a standard such as Universal Serial Bus (USB), High-Definition Multimedia Interface (HDMI®) (HDMI is a registered trademark in Japan, other countries, or both), or Bluetooth® (Bluetooth is a registered trademark in Japan, other countries, or both) can be used.

The output interface 14 includes at least one interface for output. The interface for output is, for example, a display for outputting information as video, a speaker for outputting information as audio. The display is, for example, a liquid crystal display (LCD) or an organic electro luminescent (EL) display. The output interface 14 outputs data obtained by the operations of the information processing apparatus 10. The output interface 14 may be connected to the information processing apparatus 10 as an external output device, instead of being included in the information processing apparatus 10. As an interface for connection, any interface compliant with a standard such as USB, HDMI, or Bluetooth can be used.

The communication interface 15 includes at least one interface for wireless communication with the aircraft 20. The communication interface 15 receives data from the aircraft 20 and transmits data obtained by the operations of the information processing apparatus 10 to the aircraft 20.

When the airport managed by the information processing apparatus 10 is congested and an aircraft 20 is about to land at the airport, the controller 11 acquires body information indicating whether the aircraft 20 has a fixed wing mode from the aircraft 20. The controller 11 then notifies the aircraft 20 of an instruction to hold in the air using the fixed wing mode in a case in which the aircraft 20 has the fixed wing mode, and notifies the aircraft 20 of an instruction to hold in the air using a vertical flight mode in a case in which the aircraft 20 does not have the fixed wing mode.

### <Configuration of Aircraft>

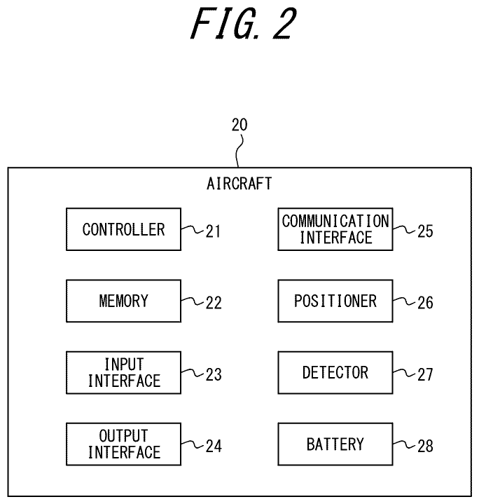

Next, a configuration of an aircraft according to an embodiment will be described with reference to FIG. 2. The aircraft 20 illustrated in FIG. 2 includes a controller 21, a memory 22, an input interface 23, an output interface 24, a communication interface 25, a positioner 26, a detector 27, and a battery 28.

Like the controller 11, the controller 21 includes at least one processor, at least one programmable circuit, at least one dedicated circuit, or any combination thereof. The controller 21 executes processes related to the operations of the aircraft 20 while controlling components of the aircraft 20.

Like the memory 12, the memory 22 includes at least one semiconductor memory, at least one magnetic memory, at least one optical memory, or any combination thereof. The memory 22 stores information to be used for the operations of the aircraft 20 and information obtained by the operations of the aircraft 20.

Like the input interface 13, the input interface 23 includes at least one interface for input. The input interface 23 accepts an operation for inputting data to be used for the operations of the aircraft 20. The input interface 23 may be connected to the aircraft 20 as an external input device, instead of being provided in the aircraft 20.

Like the output interface 14, the output interface 24 includes at least one interface for output. The output interface 24 outputs data obtained by the operations of the aircraft 20. The output interface 24, instead of being included in the aircraft 20, may be connected to the aircraft 20 as an external output device.

Like the communication interface 15, the communication interface 25 includes at least one interface for wireless communication. The communication interface 25 receives data from the information processing apparatus 10 and transmits data obtained by the operations of the aircraft 20 to the information processing apparatus 10.

The positioner 26 includes a sensor or receiver for acquiring the position of the aircraft 20 by autonomous navigation, electronic navigation, a global navigation satellite system (GNSS), or the like. Sensors for autonomous navigation include, for example, accelerometers, gyro-sensors, compasses, altimeters, and the like. Receivers for electronic navigation include, for example, VHF omni-directional radio range (VOR), instrument landing system (ILS), and other receivers for receiving radio waves from ground-based radio facilities. Furthermore, the GNSS receiver includes, for example, at least one of Global Positioning System (GPS), Quasi-Zenith Satellite System (QZSS), BeiDou, Global Navigation Satellite System (GLONASS), and Galileo receivers. The positioner 26 acquires the positional information for the aircraft 20 and outputs the positional information to the controller 21. The positional information includes altitude information of the aircraft 20.

The detector 27 includes one or more sensors, or interfaces with sensors, that detect the condition or operations of various components in the aircraft 20 and outputs information indicating the results of detection by the sensors to the controller 21. The sensors include, for example, sensors that detect the state or operation of drive mechanisms including motors, the rotational speed of propellers, the remaining charge, temperature, and charging speed of the battery 28, and the like. The sensors also include, for example, wind speed sensors, wind direction sensors, air temperature sensors, air pressure sensors, humidity sensors, illuminance sensors, rainfall sensors, cameras, and other sensors that detect conditions in the external environment of the aircraft 20.

The battery 28 provides power to the drive mechanism of the aircraft 20. The battery 28 is, for example, a lithium-ion battery, solid electrolyte battery, or nickel-metal hydride battery. The aircraft 20 may be equipped with a power supply that provides power to the battery 28.

### <Operations of Information Processing Apparatus>

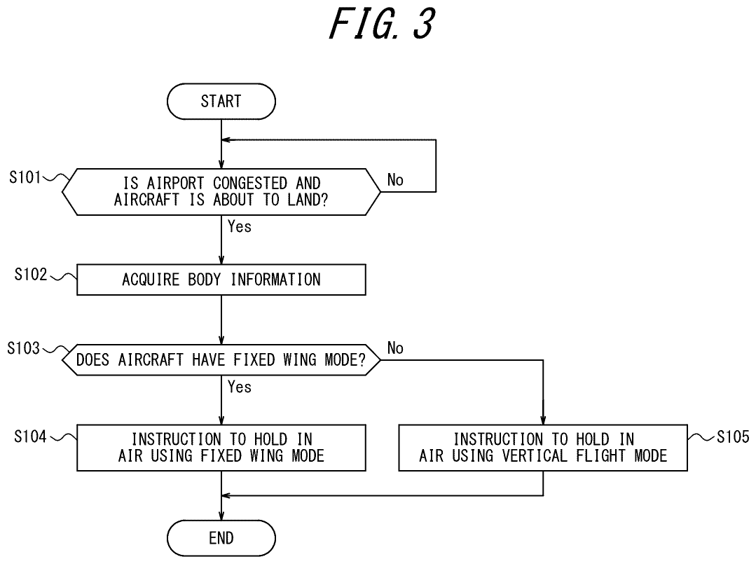

Next, first example operations of an information processing apparatus according to an embodiment will be described with reference to FIG. 3.

In step S101, the controller 11 determines whether or not the condition that the airport managed by the information processing apparatus 10 is congested and the aircraft 20 is about to land at the airport is satisfied. The determination of whether the airport is congested may be done automatically by the controller 11 or based on information acquired by the controller 11 from the user via the input interface 13. The determination of whether or not the aircraft 20 is about to land at the airport may be based on communication with the aircraft 20. For example, when the aircraft 20 is about to land at an airport, the aircraft 20 may notify the information processing apparatus 10 that manages the airport of the landing. If the controller 11 determines that the conditions are satisfied, i.e., the airport is congested and the aircraft 20 is about to land at the airport (step S101—Yes), the process proceeds to step S102. The controller 11 waits for processing until this condition is satisfied.

In step S102, the controller 11 acquires body information from the aircraft 20 via the communication interface 15. Here, “body information” includes information indicating the flight mode (fixed wing mode or not) and may include any other information on the aircraft.

In step S103, the controller 11 determines whether the aircraft 20 has a fixed wing mode based on the acquired body information. If the controller 11 determines that the aircraft 20 has a fixed wing mode (step S103—Yes), the process proceeds to step S104. If the controller 11 determines that the aircraft 20 does not have a fixed wing mode (step S103—No), the process proceeds to step S105.

In step S104, the controller 11 notifies the aircraft 20 via the communication interface 15 of an instruction to hold in the air using the fixed wing mode. Here, the “instruction to hold in the air using the fixed wing mode” is an instruction to the aircraft 20 to perform a turning operation (holding) in the air. The holding pattern at the time of holding in the air (turning operation) may be predetermined.

In step S105, the controller 11 notifies the aircraft 20 via the communication interface 15 of an instruction to hold in the air using a vertical flight mode. Here, the “instruction to hold in the air using a vertical flight mode” is an instruction to the aircraft 20 to stop in the air (hover).

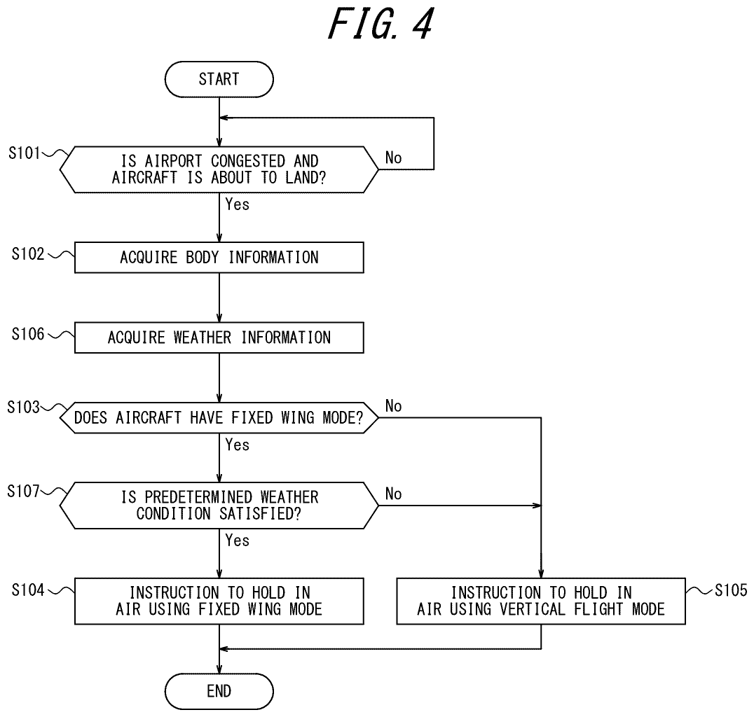

Next, second example operations of an information processing apparatus according to an embodiment will be described with reference to FIG. 4. However, the processes from step S101 to step S105 are the same as the processes illustrated in FIG. 3, and thus a description thereof is omitted.

In step S106, the controller 11 acquires weather information on the weather over the airport managed by the information processing apparatus 10. Here, “weather information” may include any information on weather, such as air currents, a wind speed, a climate, etc. The controller 11 may acquire the weather information via the communication interface 15 from a server that transmits the weather information. The controller 11 may also acquire the weather information from the user via the input interface 13. The processing of step S106 and step S102 may be done either first or in parallel.

In step S107, the controller 11 determines whether the acquired weather information satisfies the predetermined weather condition. When the controller 11 determines that the weather information satisfies the predetermined condition (step S107—Yes), the process proceeds to step S104. When the controller 11 determines that the weather information does not satisfy the predetermined condition (step S107—No), the process proceeds to step S105. The processing of step S107 and step S103 may be performed either first or in parallel.

Here, the “predetermined weather condition” is a weather condition suitable for holding in the air in the fixed wing mode or unsuitable for holding in the air using the vertical flight mode. For example, a predetermined weather condition may be the condition that the stability of the air current is equal to or greater than a threshold. This is because when the air current is stable, the risk of swirling motion is considered low. For example, a predetermined weather condition may be the condition that the wind speed is less than a threshold. This is because when wind speeds are low, the risk of turning movements is considered to be small. For example, a predetermined weather condition may be the condition that the climate is clear. This is because when the weather is clear, the visibility is good and the likelihood of an accident with another aircraft 20 is considered low. For example, a predetermined weather condition may be the condition that a downdraft is occurring. This is because vertical flight is considered difficult when downdrafts are occurring.

### Variations

Although not illustrated in FIG. 4, the controller 11 may acquire information indicating the number of aircraft 20 holding over the airport, either together with or instead of the processing of step S106. The controller 11 may then determine, together with or instead of the processing of step S107, whether the number of aircraft 20 holding over the airport is below the threshold. If the number of aircraft 20 holding over the airport is less than the threshold, the controller 11 proceeds to step S104. If the number of aircraft 20 holding over the airport exceeds the threshold, the controller 11 proceeds to step S105. This is because if the number of aircraft 20 holding over the airport exceeds the threshold, the turning movement is likely to cause accidents with other aircraft 20.

In an example, the information processing apparatus 10 and/or the aircraft 20 may be used to provide Mobility as a Service (MaaS), a service that leverages mobility. In an example, the above processing steps may be executed when providing a service (MaaS) using the information processing apparatus 10 and/or the aircraft 20. In this case, the information processing method according to the above processing steps is an example of a method of providing a service (MaaS) using the information processing apparatus 10 and/or the aircraft 20.

As described above, the information processing apparatus 10 according to the present embodiment receives body information indicating whether the aircraft 20 has the fixed wing mode from the aircraft 20 when the airport is congested and the aircraft 20 is about to land at the airport. If the aircraft 20 has a fixed wing mode, the information processing apparatus 10 transmits an instruction to hold in the air using the fixed wing mode to the aircraft 20, and if the aircraft 20 does not have a fixed wing mode, it transmits an instruction to hold in the air using the vertical flight mode to the aircraft 20.

When the aircraft 20 holds in the air, the fixed wing mode is more energy efficient than the vertical flight mode because it can generate lift with its larger wings. Therefore, according to such a configuration, it is possible to improve the energy efficiency of the aircraft 20 when it holds in the air by using both the fixed wing mode and the vertical flight mode when it holds in the air.

### <Program>

The functions of the information processing apparatus 10 are realized by execution of a program according to the present embodiment by a processor serving as the controller 11. That is, the functions of the information processing apparatus 10 are realized by software. The program causes a computer to execute the operations of the information processing apparatus 10, thereby causing the computer to function as the information processing apparatus 10. That is, the computer executes the operations of the information processing apparatus 10 in accordance with the program to thereby function as the information processing apparatus 10.

The program can be stored on a non-transitory computer readable medium. The non-transitory computer readable medium is, for example, flash memory, a magnetic recording device, an optical disc, a magneto-optical recording medium, or ROM. The program is distributed, for example, by selling, transferring, or lending a portable medium such as a Secure Digital (SD) card, a digital versatile disc (DVD) or a compact disc read only memory (CD-ROM) on which the program is stored. The program may be distributed by storing the program in a storage of a server and transferring the program from the server to another computer. The program may be provided as a program product.

For example, the computer temporarily stores, in a main memory, the program stored in the portable medium or the program transferred from the server. Then, the computer reads the program stored in the main memory using the processor, and executes processes in accordance with the read program using the processor. The computer may read the program directly from the portable medium, and execute processes in accordance with the program. The computer may, each time a program is transferred from the server to the computer, sequentially execute processes in accordance with the received program. The processing may be executed through a so-called application service provider (ASP) type service which realizes functions merely by execution of instructions and acquisition of results, without transferring the program from the server to the computer. The program encompasses information that is to be used for processing by an electronic computer and is thus equivalent to a program. For example, data that is not a direct command to a computer but has a property that regulates processing of the computer is “equivalent to a program” in this context.

Some or all of the functions of the information processing apparatus 10 may be realized by a programmable circuit or a dedicated circuit serving as the controller 11. That is, some or all of the functions of the information processing apparatus 10 may be realized by hardware.

The embodiments described above are representative examples, but various variations or changes are possible without departing from the intent of this disclosure. For example, it is possible to combine several into one or divide one into several with respect to the component blocks or processing steps described in the embodiment.

1. An information processing apparatus comprising a controller, the information processing apparatus being configured to communicate with aircraft,
wherein the controller is configured to:
acquire body information indicating whether an aircraft has a fixed wing mode from the aircraft in a case in which an airport is congested and the aircraft is about to land at the airport; and
notify the aircraft of an instruction to hold in air using the fixed wing mode in a case in which the aircraft has the fixed wing mode, and notify the aircraft of an instruction to hold in air using a vertical flight mode in a case in which the aircraft does not have the fixed wing mode.

2. The information processing apparatus according to claim 1,
wherein the controller is configured to:
further acquire weather information on weather over the airport in a case in which the airport is congested and the aircraft is about to land at the airport; and
notify the aircraft of the instruction to hold in air using the fixed wing mode in a case in which the aircraft has the fixed wing mode and the weather information satisfies a predetermined weather condition, and notify the aircraft of the instruction to hold in air using the vertical flight mode in a case in which the aircraft does not have the fixed wing mode or the weather information does not satisfy the predetermined weather condition.

3. The information processing apparatus according to claim 2, wherein the weather information includes information on an air current, a wind speed, or a climate.

4. An aircraft control method comprising:
acquiring, by an information processing apparatus configured to communicate with aircraft, body information indicating whether an aircraft has a fixed wing mode from the aircraft in a case in which an airport is congested and the aircraft is about to land at the airport; and
notifying, by the information processing apparatus, the aircraft of an instruction to hold in air using the fixed wing mode in a case in which the aircraft has the fixed wing mode, and notifying, by the information processing apparatus, the aircraft of an instruction to hold in air using a vertical flight mode in a case in which the aircraft does not have the fixed wing mode.

5. A method, by a processor, for improving travel mobility as a service (MaaS), comprising processing steps executed by the information processing apparatus according to claim 1.
